(19) United States
(12) Patent Application Publication
(10) Pub. No.: US 2011/0078477 A1
(43) Pub. Date: Mar. 31, 2011

(54) POWER MANAGEMENT METHOD FOR ELECTRONIC DEVICE

(75) Inventor: Jong-Lae PARK, Suwon-si (KR)

(73) Assignee: SAMSUNG ELECTRONICS CO., LTD., Suwon-si (KR)

(21) Appl. No.: 12/886,729

(22) Filed: Sep. 21, 2010

(30) Foreign Application Priority Data
Sep. 29, 2009 (KR) 10-2009-0092126

(51) Int. Cl. G06F 1/32

(52) U.S. Cl. 713/322; 713/323

(57) ABSTRACT

An electronic device performs power management by switching between an active mode and an idle mode. The active mode is launched by applying a main clock signal to a processor within the electronic device. The idle mode is launched in parallel with a scaling down of a power level of processor.

### CROSS-REFERENCE TO RELATED APPLICATIONS

This application claims priority under 35 USC §119 to Korean Patent Application No. 10-2009-0092126 filed on Sep. 29, 2009, the disclosure of which is hereby incorporated by reference in its entirety.

### BACKGROUND

Embodiments of the inventive concept relate generally to power management of electronic devices. More particularly, embodiments of the inventive concept relate to methods of dynamically controlling power management in electronic devices comprising a processor.

The computing capability of electronic devices continues to improve with the advancement of technology. In many devices, the main source of computing capability is a high frequency microprocessor. However, because high frequency operation can lead to significant power consumption, many electronic devices have different operating modes designed to modify power consumption according to device usage. For instance, many cellular telephones have a standby mode that disables certain functions when a user does not provide any input to the telephone for a certain period of time.

The different operating modes of electronic devices can be roughly divided into two categories, referred to as active modes and standby modes. The active modes include, for instance, a traffic mode used by a telephone while a user is conducting a telephone call, or a normal operating mode used by a laptop while application programs are running The standby modes include, for instance, an idle mode where power consumption is reduced but prompt operation is still possible in response to a user input, and a sleep mode where numerous functions of a device are disabled but the device can be awakened without complete rebooting. Traditionally, each of the standby modes reduces power consumption by blocking the power supply to some components of an electronic device.

### SUMMARY

Embodiments of the inventive concept provide methods of performing power management in electronic devices. Embodiments of the inventive concept also provide apparatuses employing the methods. In certain embodiments, a power management method performs power level scaling after an electronic device transitions from an active mode to an idle mode. This can increase the operational stability of a processor in the electronic device.

According to an embodiment of the inventive concept, a method is provided for managing power consumption in an electronic device comprising a processor. The method comprises launching an active mode of the device by applying a main clock signal to the processor, and launching an idle mode of the device in parallel with scaling a power level of the processor.

In certain embodiments, scaling the power level of the processor comprises adjusting a frequency of the main clock signal or a magnitude of a main power supply voltage of the processor based on a workload rate of the processor.

In certain embodiments, launching the idle mode in parallel with scaling the power level of the processor comprises generating a level control signal after the processor completes a processing task, and blocking the main clock signal from being applied to the processor after the processor completes the processing task.

In certain embodiments, the processor is configured to perform a power management program to generate the level control signal, and the main clock signal is blocked from being applied to the processor after the level control signal is generated by the processor.

In certain embodiments, at least one of the frequency of the main clock signal and a magnitude of a main power supply voltage is adjusted by a voltage-clock provider based on the level control signal.

In certain embodiments, the power management program is a subroutine called by an operating system of the processor.

In certain embodiments, the processor is configured to generate a processor state signal indicating the active mode or the idle mode of the processor, and the main clock signal is blocked from being applied to the processor after the processor state signal is deactivated to indicate the idle mode.

In certain embodiments, the level control signal is generated by a power management unit based on the workload rate of the processor, the power management unit is located outside the processor and is configured to output the level control signal in response to the processor state signal, and at least one of a frequency of the main clock signal and a magnitude of a main power supply voltage of the processor is adjusted by a voltage-clock provider based on the level control signal received from the power management unit.

In certain embodiments, the power level of the processor is scaled as a consequence of the active mode being maintained for a reference time.

In certain embodiments, the reference time is determined based on a number of interrupts generated by a system timer.

In certain embodiments, the work load rate of the processor is measured by calculating an average of a plurality of unit load rates, wherein each unit load rate indicates a workload of the processor per unit time.

In certain embodiments, the workload rate of the processor is measured by calculating a weighted average of a plurality of unit load rates, wherein each unit load rate indicates a workload of the processor per unit time, and a greater weigh is applied to a more recent unit load rate among the plurality of unit load rates than to a less recent unit load rate among the plurality of unit load rates.

In certain embodiments, the workload rate of the processor is generated by a workload detector located outside the processor.

In certain embodiments, the workload rate of the processor is generated by a subroutine called by an operating system of the processor.

In certain embodiments, a power level interrupt signal is generated by an interrupt controller outside the processor where the active mode is maintained for the reference time, and the power level of the processor is scaled in response to the power level interrupt signal.

In certain embodiments, the power level interrupt signal is generated based on a number of interrupts provided from a system timer and a processor state signal, wherein the processor state signal indicates the active mode or the idle mode of the processor.

According to another embodiment of the inventive concept, an electronic device having an active mode and an idle mode is provided. The device comprises a processor that operates according to a main clock signal and a main power supply voltage, and a voltage-clock provider that provides the main clock signal and the main power supply voltage to the processor, and scales a power level of the electronic device during a transition of the electronic device from the active mode to the idle mode by reducing a frequency of the main clock signal or a magnitude of the main power supply voltage.

In certain embodiments, the electronic device further comprises a switch that disconnects the main clock signal from the processor during the transition of the electronic device from the active mode to the idle mode.

According to still another embodiment of the inventive concept, a method is provided for operating an electronic device comprising a processor and a voltage-clock provider that provides a main clock signal and a main power supply voltage to the processor. The method comprises performing a processing task on the processor, upon completion of the processing task, executing a power management program on the processor to actuate a level control signal and a processor state signal, in response to the actuation of the processor state signal, operating a switch to interrupt the supply of the main clock signal to the processor, in response to the level control signal and in parallel with the operation of the switch, operating the voltage-clock provider to reduce a frequency of the main clock signal or a magnitude of the main power supply voltage.

In certain embodiments, the power management program is implemented in a software routine of an operating system of the processor.

### BRIEF DESCRIPTION OF THE DRAWINGS

The drawings illustrate selected embodiments of the inventive concept. In the drawings, like reference numbers indicate like features.

FIG. 1 is a flowchart illustrating a method of performing power management in an electronic device according to an embodiment of the inventive concept.

FIG. 2 is a hysteresis diagram illustrating voltage changes in a power level scaling operation of an electronic device according to an embodiment of the inventive concept.

FIG. 3 is a diagram illustrating power levels used in a power management method according to an embodiment of the inventive concept.

FIG. 4 is a block diagram illustrating an electronic device that performs power management according to an embodiment of the inventive concept.

FIG. 5 is a flowchart illustrating a method of performing power management in the device of FIG. 4 according to an embodiment of the inventive concept.

FIG. 6 is a block diagram illustrating an electronic device that performs power management according to an embodiment of the inventive concept.

FIG. 7 is a flowchart illustrating a method of performing power management in the device of FIG. 6 according to an embodiment of the inventive concept.

FIG. 8 is a block diagram illustrating a power management unit in the device of FIG. 6 according to an embodiment of the inventive concept.

FIG. 9 is a diagram illustrating a circuit that generates an output control signal in the power management unit of FIG. 8.

FIG. 10 is a timing diagram illustrating a method of performing power management in an electronic device according to an embodiment of the inventive concept.

FIG. 11 is a timing diagram illustrating a method of performing power management in an electronic device according to another embodiment of the inventive concept.

FIG. 12 is a circuit diagram illustrating a power management unit in the device of FIG. 6 according to an embodiment of the inventive concept.

FIG. 13 is a timing diagram illustrating power level changes in a power management method according to an embodiment of the inventive concept.

FIG. 14 is a diagram illustrating a voltage-clock provider in the device of FIG. 6 according to an embodiment of the inventive concept.

FIG. 15 is a diagram for describing an effect of a power management method according to an embodiment of the inventive concept.

### DETAILED DESCRIPTION OF EMBODIMENTS

Embodiments of the inventive concept are described below with reference to the corresponding drawings. These embodiments are presented as teaching examples and should not be construed to limit the scope of the inventive concept.

In the description that follows, the terms first, second, third etc. are used to describe various elements. However, the described elements should not be limited by these terms, as they are used merely to distinguish one element from another. Thus, a first element discussed below could be termed a second element without departing from the teachings of the inventive concept. As used herein, the term “and/or” includes any and all combinations of one or more of the associated listed items.

Where an element is referred to as being “connected” or “coupled” to another element, it can be directly connected or coupled to the other element or intervening elements may be present. In contrast, where an element is referred to as being “directly connected” or “directly coupled” to another element, there are no intervening elements present. Other words used to describe relationships between elements should be interpreted in a like fashion (e.g., “between” versus “directly between,” “adjacent” versus “directly adjacent,” etc.).

The terminology used herein is for the purpose of describing example embodiments only and is not intended to be limiting of the inventive concept. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In general, embodiments of the inventive concept provide electronic devices that conserve power by operating at lower frequencies or operating voltages in standby modes. Certain embodiments incorporate techniques for stabilizing device operation in the presence of the varied operating frequencies and voltages.

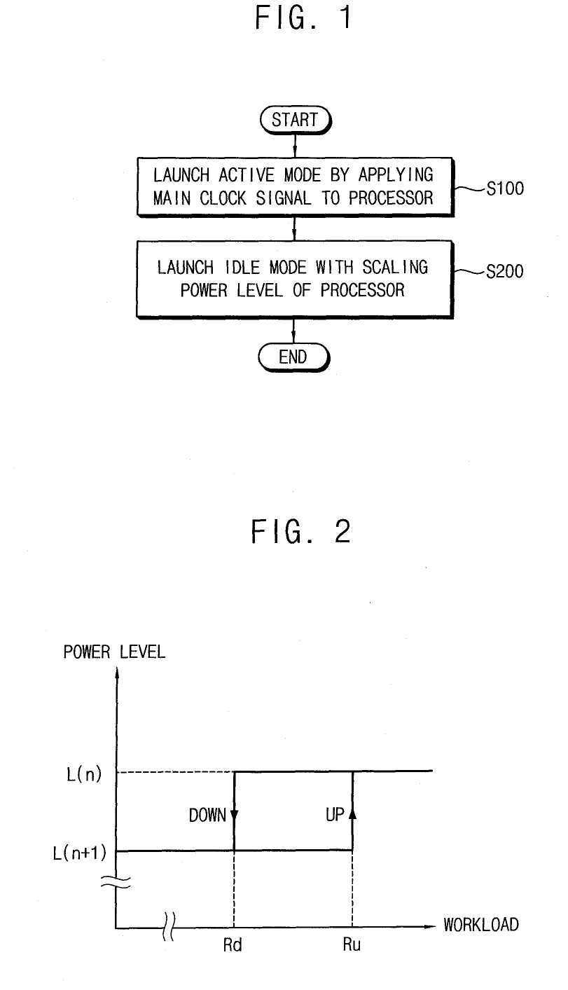

FIG. 1 is a flowchart illustrating a method of performing power management in an electronic device according to an embodiment of the inventive concept. In the description that follows, example method steps will be indicated by parentheses (SXXX).

The method of FIG. 1 is performed in an electronic device comprising a processor. The processor receives a main clock signal having a frequency and voltage level that can be varied according to different operation modes of the electronic device.

Referring to FIG. 1, an active mode of the electronic device is launched, or initiated, by applying the main clock signal to the processor (S100). An idle mode is launched with scaling down a power level of the processor (S200). The power level is scaled down after the operation mode changes from the active mode to the idle mode. This scaling down is typically accomplished by decreasing the frequency or voltage level of the main clock signal. This scaling can also produce an unstable state of the voltage level and/or frequency.

The electronic device transitions from the active mode to the idle mode upon detecting that a workload rate of the processor falls below a first threshold. The electronic device transitions from the idle mode to the active mode upon detecting that the workload rate of the processor rises above a predetermined threshold. As will be described with reference to FIG. 2, the first threshold can be lower than the second threshold.

The workload rate or load rate of the processor can be defined as a ratio of a current workload W_{c} of the processor to a maximum workload Wₘₐₓ of the processor. In other words, the workload rate R_{w} can be expressed as an equation R_{w}=W_{c}/Wₘₐₓ. An idle rate of the processor can be defined as a ratio of a difference between the maximum workload Wₘₐₓ and the current workload W_{c} to the maximum workload Wₘₐₓ. In other words, the idle rate R_{I} can be expressed as an equation R_{I}=(Wₘₐₓ-W_{c})/Wₘₐₓ. Accordingly the sum of the workload rate and the idle rate is one. The workload rate can be measured non-periodically as required, or it may be measured periodically to determine an operation mode at specific intervals.

In the description that follows, a power level of an electronic device indicates a rate of power consumption by the device. The power level can be adjusted, for instance, by changing a frequency of a main clock signal of the device or a magnitude of a main power supply voltage of the device. At different power levels, a processor can perform the same processing task with different power consumption and at different speeds.

Much of the power consumption of a particular signal occurs when the signal is switched, such as when it transitions from logic high to logic low and vice versa. Consequently, the power consumption of a processor increases as the frequency of its main clock signal increases. As a result, the power consumption of an electronic device can be unnecessarily high where its operating frequency and/or power supply voltage is high compared with the workload rate of a corresponding processor.

As indicated above, power level scaling can be performed by adjusting both the frequency of a main clock signal and the magnitude of a main power supply voltage of a processor. As the frequency of the main clock signal increases, the main power supply voltage may be required to increase to support switching speed of elements such as transistors. Accordingly, as the frequency of the clock signal increases, the power supply voltage applied to the processor may be increased by a commensurate amount. In general, as the power supply voltage increases, the power consumption increases accordingly.

Where the magnitude of the power supply voltage and the frequency of the clock signal are changed, a voltage regulator and a phase locked loop (PLL) can require a time interval to stabilize the voltage and the frequency. In some methods of power management, the power level is scaled when the operation mode transitions from the idle mode to the active mode or during the active mode. During this transition, the operation of the processor can become unstable for any of several reasons. For instance, the voltage or frequency can become unstable because of design errors and production errors of a printed circuit board (PCB), defects of a power management integrated circuit (PMIC), and temporary instability caused by an abrupt increase of current during a wake-up transition from the idle mode to the active mode. Accordingly, in certain embodiments of the inventive concept, operational stability is achieved by allowing an unstable state of a voltage and/or frequency occur in the idle mode by performing power level scaling in a transition time from the active mode to the idle mode.

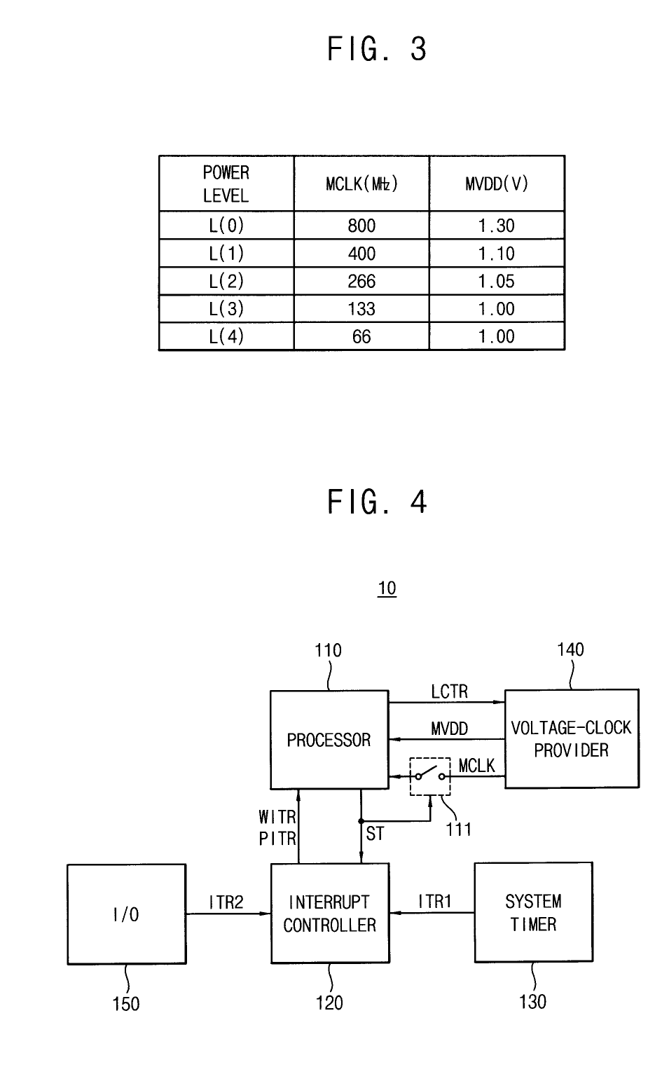

FIG. 2 is a hysteresis diagram illustrating voltage changes in a power level scaling operation of an electronic device according to an embodiment of the inventive concept, and FIG. 3 is a diagram illustrating an example of power levels used in a method of performing power management according to an embodiment of the inventive concept.

In the embodiments of FIGS. 2 and 3, power level scaling is performed through dynamic voltage and frequency scaling (DVFS). DVFS is a method of changing the voltage and/or the frequency dynamically according to the operation state of the processor. As illustrated in FIG. 2, DVFS can be performed according to a hysteresis scheme.

In FIG. 2, the label “UP” indicates that a power level is increased from a relatively low level L(n+1) to a relatively high level L(n) as the workload rate of a processor rises above an upward reference value Ru. This increase can be performed, for instance, where the speed of the processor is low compared with a current workload. The increased power level can be achieved by raising the frequency of the clock signal.

In FIG. 2, the label “DOWN” indicates that a power level is decreased from the relatively high level L(n) to the relatively low level L(n+1) as the workload rate of the processor falls below a downward reference value Rd. This decrease can be performed, for instance, where the speed of the processor is high compared with the current workload. The decreased power level can be achieved by reducing the frequency of the clock signal.

The hysteresis scheme of FIG. 2 is implemented by setting downward reference value Rd to be smaller than upward reference value Ru. As the difference between the upward reference value and the downward reference value increases, the power level tends to remain unchanged for a relatively wider range of workload values. On the other hand, as the difference between the upward reference value and the downward reference value decreases, the power level may change more frequently. In other words, as the difference between the upward reference value Ru and the downward reference value Rd increases, the operation stability of the processor may improve while power consumption increases, and as the difference between upward reference value Ru and downward reference value Rd decreases, the performance of the processor may degrade due to more frequent changes of the power level. Thus upward reference value Ru and downward reference value Rd can be determined based on characteristics of the processor and power consumption.

FIG. 3 illustrates example frequencies of a main clock signal and example magnitudes of a main power supply voltage of a processor in an electronic device. These frequencies and magnitudes correspond to respective power levels L(0) through L(4). These frequencies and magnitudes can be applied to a device such as that illustrated in FIG. 4.

The number of power levels, the frequencies of the main clock signal, and the magnitudes of the main power supply voltage corresponding to each power level can be changed variously according to the function and type of the processor. As illustrated in FIG. 3, the power level can be subdivided into two or more levels, and power level scaling can be performed by raising or lowering the power level step by step.

FIG. 4 is a block diagram illustrating an electronic device that performs power management according to an embodiment of the inventive concept.

Referring FIG. 4, a device 10 comprises a processor 110, an interrupt controller 120, a system timer 130, a voltage-clock provider 140 and an input-output (I/O) unit 150.

Device 10 can take various forms, such as a mobile communication handset or a computing system. Although not illustrated in FIG. 4, device 10 can further comprise a memory, a built-in battery, or another peripheral device. I/O unit 150 comprises an input device, such as a keyboard, touch pad, etc., an output device, such as a display, speaker, etc., and an I/O interface.

Processor 110 can comprise a central processing unit (CPU), a digital signal processor (DSP), a micro controller, a memory controller, or an arbitrary controller performing various operations such as arithmetic calculations, memory access operations, and so on. Processor 110 receives main clock signal MCLK and a main power supply voltage MVDD from voltage-clock provider 140, and operates in synchronization with a main clock signal MCLK. Processor 110 has an active mode and an idle mode such as those described with reference to FIGS. 1 and 2.

Interrupt controller 120 generates a wake-up interrupt WITR in response to a first interrupt ITR1 from system timer 130 and a second interrupt ITR2 from I/O unit 150. First interrupt ITR1 is activated periodically, and second interrupt ITR2 is activated in response to a specific event, such as an input from a keyboard or a touch pad.

The active mode of processor 110 is launched when wake-up interrupt WITR is activated in the idle mode. Processor 110 activates a processor state signal ST to launch the active mode, a switch 111 is turned on in response to the activation of processor state signal ST is activated, and then main clock signal MCLK is applied to processor 110. Although FIG. 4 illustrates switch 111 outside processor 110, switch 111 can also be embedded in processor 110.

Processor 110 enters the idle mode after a processing task is completed. To launch the idle mode, processor 110 generates a level control signal LCTR by performing a power management program. In certain embodiments, the power management program comprises a subroutine called by an operating system (OS) and executed by processor 110. Processor 110 deactivates processor state signal ST after generating level control signal LCTR. Switch 111 is turned off in response to deactivation of processor state signal ST to block main clock signal MCLK from being applied to processor 110.

Voltage-clock provider 140 outside processor 110 adjusts at least one of the frequency of main clock signal MCLK and the magnitude of main power supply voltage MVDD supplied to processor 110, in response to level control signal LCTR from processor 110. Accordingly, device 10 allows an unstable state of the voltage and/or the frequency to occur in the idle mode by performing scaling of the power level while the active mode is changed to the idle mode. This can improve operational stability of processor 110.

In certain alternative embodiments, the power level scaling of processor 110 is performed regardless of a transition to the idle mode, where the active mode is maintained longer than a reference time. In these embodiments, interrupt controller 120 activates a power level interrupt PITR supplied to processor 110 if processor state signal ST remains activated longer than the reference time. Where power level interrupt PITR is activated during the active mode, processor 110 generates level control signal LCTR by performing the power management program described above, and then voltage-clock provider 140 adjusts at least one of the frequency of main clock signal MCLK and the magnitude of main power supply voltage MVDD in response to level control signal LCTR. The reference time can be determined, for instance, from a number of interrupts supplied from system timer 130.

Interrupt controller 120 counts the number of activations of first interrupt ITR1 from system timer 130 while processor state signal ST is activated, and then interrupt controller 120 activates power level interrupt PITR where the number of counts reaches a reference value. There is need to raise the frequency of main clock signal MCLK and/or the magnitude of main power supply voltage MVDD where the processor is maintained in the active mode without entering the idle state. Even though the processor is in the active mode, the power level can be scaled to prevent a malfunction of processor 110 due to overloads, regardless whether it enters the idle mode.

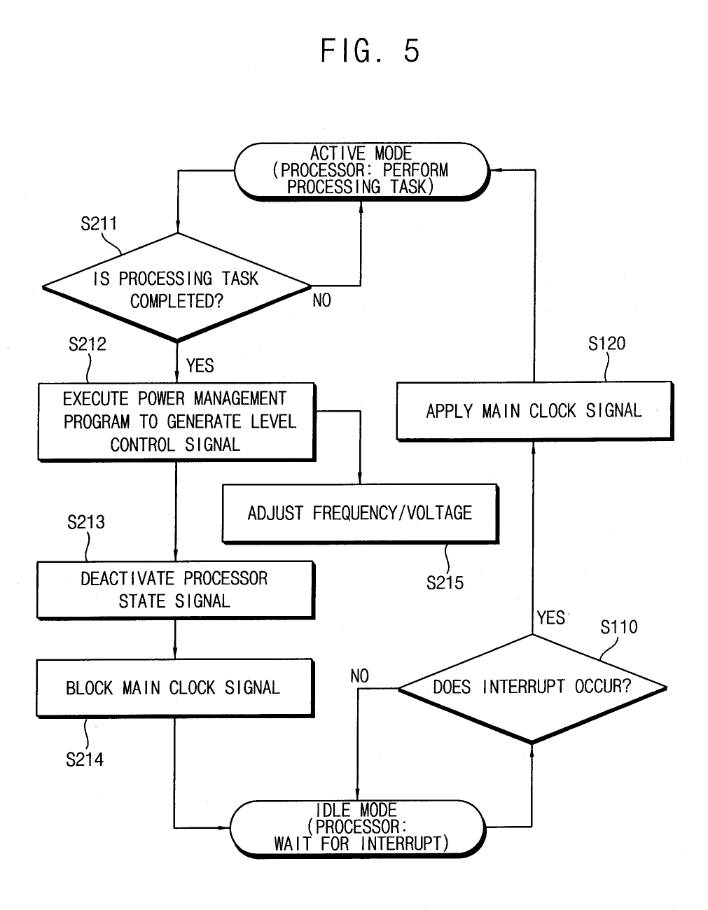

FIG. 5 is a flowchart illustrating a method of power management performed by the device of FIG. 4 according to an embodiment of the inventive concept.

The active mode indicates a state where processor 110 is running, such as when it is performing a processing task. The idle mode indicates a state where processor 110 is not running, such as where it is waiting for a wake-up interrupt. Main clock signal MCLK is blocked from processor 110 in the idle mode to reduce power consumption.

Where the processing task is completed (S211=YES), processor 110 generates level control signal LCTR by executing the power management program (S212). Processor 110 deactivates processor state signal ST (S213) after level control signal LCTR is generated from processor 110, and blocks main clock signal MCLK from being applied to processor 110 (S214) by turning off switch 111 in response to processor state signal ST. Meanwhile, in parallel with blocking main clock signal MCLK, voltage-clock provider 140 adjusts at least one of the frequency of main clock signal MCLK and the magnitude of main power supply voltage MVDD (S215) supplied to processor 110, in response to level control signal LCTR generated from processor 110.

Where the wake-up interrupt occurs in the idle mode (S110=YES), processor 110 activates processor state signal ST, and then main clock signal MCLK is applied to processor 110 (S120) by turning on switch 111 in response to processor state signal ST.

In the method of FIG. 5, the power level is scaled while the idle mode is launched. In particular, the power level is scaled by generating level control signal LCTR after processor 110 completes the processing task, and then blocking application of main clock signal MCLK to processor 110. Consequently, operational stability can be preserved by allowing an unstable state of the voltage and/or the frequency to occur in the idle mode.

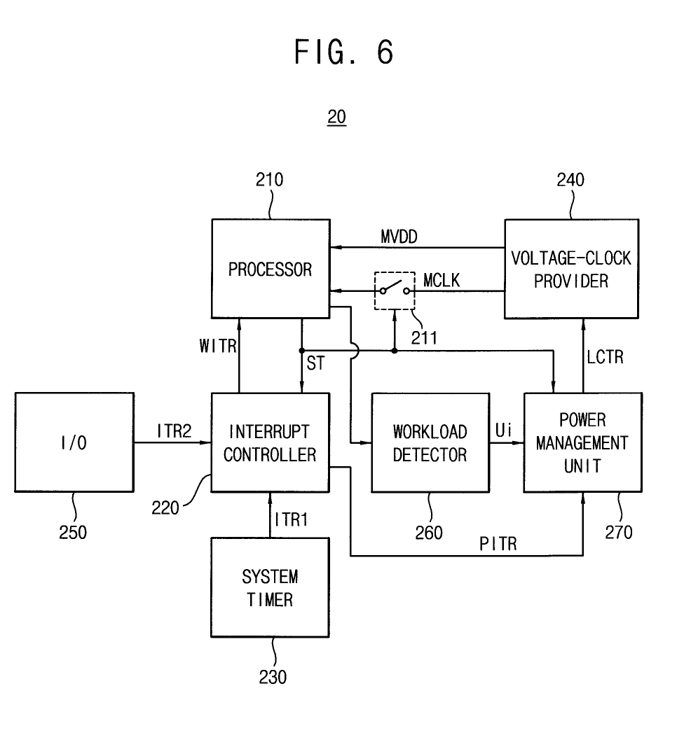

FIG. 6 is a block diagram illustrating a device that performs power management according to another embodiment of the inventive concept.

Referring FIG. 6, a device 20 comprises a processor 210, an interrupt controller 220, a system timer 230, a voltage-clock provider 240, an I/O unit 250, a workload detector 260, and a power management unit 270.

Device 20 can take a variety of forms, such as a mobile communication handset or a computing system. Although not illustrated in FIG. 6, device 20 can further comprise a memory, a built-in battery, and other peripheral devices. I/O unit 250 comprises an input device, such as a keyboard, touch pad, etc., an output device, such as a display, speaker, etc., and an I/O interface.

Processor 210 can be a CPU, a DSP, a micro controller, a memory controller, or any of several other types of controller capable of performing various operations such as arithmetic calculations, memory access operations, and so on. Processor 210 receives main clock signal MCLK and main power supply voltage MVDD from voltage-clock provider 240, and operates in synchronization with main clock signal MCLK.

Interrupt controller 220 generates a wake-up interrupt WITR in response to a first interrupt ITR1 from system timer 230 and a second interrupt ITR2 from I/O unit 250. First interrupt ITR1 is a signal activated periodically, and second interrupt ITR2 is a signal activated in response to a specific event, such as an input received through a keyboard or a touch pad.

The active mode of processor 210 is launched when wakeup interrupt WITR is activated in the idle mode. Processor 210 activates a processor state signal ST for launching the active mode, a switch 211 is turned on when processor state signal ST is activated, and then main clock signal MCLK is applied to processor 210. Although FIG. 6 illustrates switch 211 outside processor 210, switch 211 can also be embedded in processor 210.

Processor 210 enters the idle mode after the processing task is completed. In the embodiment of FIG. 4, level control signal LCTR is generated based on the power management program executed by processor 110. Accordingly, main clock signal MCLK is blocked after level control signal LCTR is generated from processor 110. On the other hand, in the embodiment of FIG. 6, power management unit 270 outside processor 210 generates level control signal LCTR to change the power level. Thus processor 210 of FIG. 6 deactivates processor state signal ST immediately upon completion of the processing task. Switch 211 is turned off in response to the deactivation of processor state signal ST to block main clock signal MCLK from being applied to processor 210.

Workload detector 260 detects the workload rate by monitoring the operation state of processor 210. For example, workload detector 260 can detect the workload rate of processor 210 at periodic intervals and provide a unit load rate Ui at each interval. Workload detector 260 can be embodied in various ways to provide the workload rate or the idle rate of processor 210.

Power management unit 270 receives the workload rates Ui provided from workload detector 260, and generates level control signal LCTR to change the power level of processor 210.

Power management unit 270 can be a physical component embodied as hardware outside processor 210, or at least some parts of power management unit 270 can be integrated into other components. For example, power management unit 270 can be a part of processor 210, or it can be embodied in the power management program in processor 210, similar to the embodiment of FIG. 4. Where at least some part of power management unit 270 is embodied in software, power management unit 270 can be stored into the memory in the form of executable code, and the power level can be scaled by the code. As described above, where the power management program corresponding to power management unit 270 is executed under the control of the OS of processor 210, it can be embodied as a subroutine called by the OS.

In certain embodiments, power management unit 270 generates power level control signal LCTR to change the power level where processor state signal ST is deactivated. Voltage-clock provider 240 adjusts at least one of the frequency of main clock signal MCLK and the magnitude of main power supply voltage MVDD applied to processor 210, in response to the level control signal LCTR from power management unit 270. Accordingly, device 20 allows an unstable state of the voltage and/or the frequency to occur in the idle mode by performing scaling of the power level when the active mode is changed to the idle mode. As a result, operational stability of the processor can be preserved.

In certain alternative embodiments, the power level scaling of processor 210 can be performed regardless of a transition to the idle mode where the active mode is maintained longer than a reference time. Interrupt controller 220 can activate a power level interrupt PITR supplied to power management unit 270 where processor state signal ST remains activated longer than the reference time. Where power level interrupt PITR is activated during the active mode, power management unit 270 generates level control signal LCTR in response to power level interrupt PITR, and then voltage-clock provider 240 adjusts at least one of the frequency of main clock signal MCLK and the magnitude of main power supply voltage MVDD in response to level control signal LCTR. Accordingly, where the processor is maintained in the active mode without entering the idle state, the power level can be scaled to prevent a malfunction of processor 210 due to overheating or other forms of work overloads.

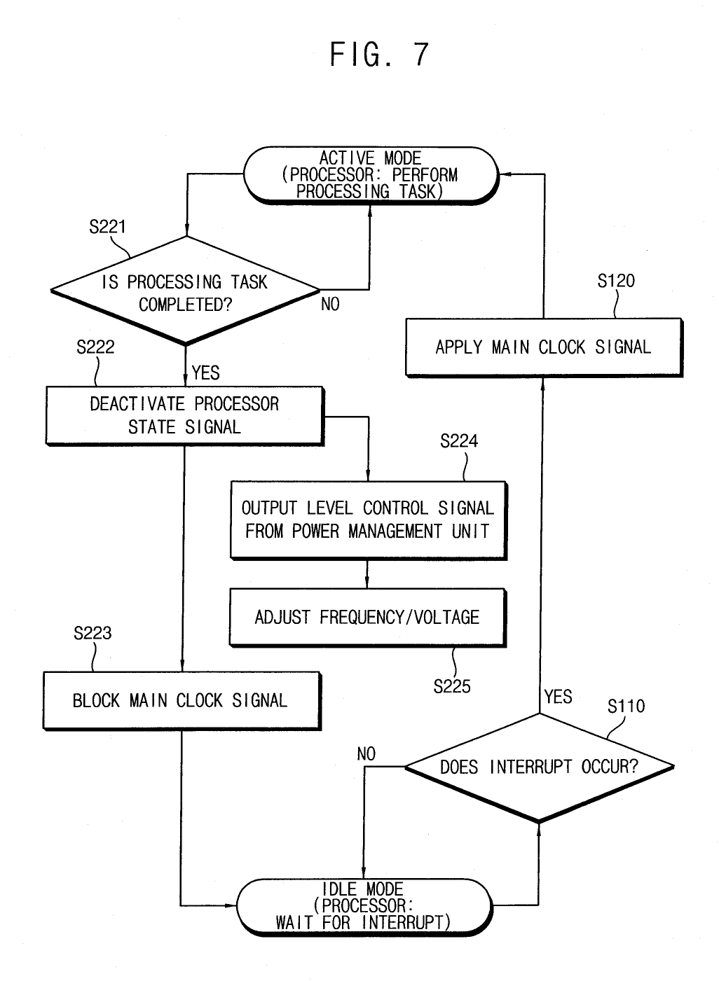

FIG. 7 is a flowchart illustrating a method of performing power management in the device of FIG. 6 according to an embodiment of the inventive concept.

In the embodiment of FIG. 7, an active mode indicates a state where processor 210 is running, or in other words, a state where processor 210 is performing a processing task. An idle mode indicates a state where processor 210 is not running, or in other words, a state where processor 210 is waiting for a wake-up interrupt. In the idle mode, main clock signal MCLK is blocked from processor 210 to reduce power consumption.

Upon completion of the processing task (S221=YES), processor 210 deactivates processor state signal ST (S222), and then switch 211 is turned off in response to processor state signal ST. Consequently, main clock signal MCLK is blocked from being applied to processor 210 (S223). Meanwhile, in parallel with blocking main clock signal MCLK, power management unit 270 generates level control signal LCTR to adjust the power level of processor 210 where processor state signal ST is deactivated (S224). Then voltage-clock provider 240 adjusts at least one of the frequency of main clock signal MCLK and the magnitude of power supply voltage MVDD (S225) supplied to processor 210, in response to level control signal LCTR from power management unit 270.

Where the wake-up interrupt occurs in the idle mode (S110=YES), processor 210 activates processor state signal ST, and then main clock signal MCLK is applied to processor 210 (S120) by turning on switch 211 in response to processor state signal ST. Accordingly, to scale the power level in response to the idle mode, level control signal LCTR is generated after processor 210 completes the processing task, and then main clock signal MCLK is blocked from processor 210. The operational stability of processor 210 is preserved by allowing an unstable state of the voltage and/or the frequency to occur in the idle mode by performing power level scaling while the idle mode is launched.

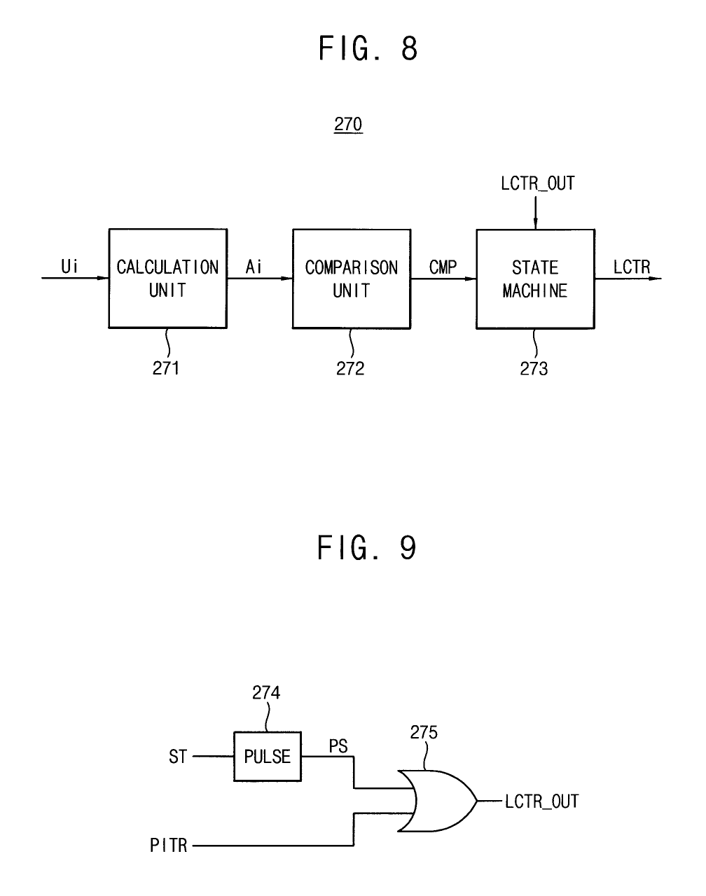

FIG. 8 is a block diagram illustrating a power management unit in the device of FIG. 6 according to an embodiment of the inventive concept.

Referring FIG. 8, power management unit 270 comprises a calculation unit 271, a comparison unit 272, and a state machine 273.

Calculation unit 271 receives unit workload rates Ui provided by workload detector 260, and then outputs a present workload rate Ai by calculating an average of the unit workload rates Ui. Comparison unit 272 compares the present workload rate Ai to upward reference value Ru and downward reference value Rd, respectively. Then, comparison unit 272 generates a comparison signal CMP indicating whether the power level should be shifted up or down. Comparison signal CMP is stored in state machine 273, and state machine 273 outputs level control signal LCTR to voltage-clock provider 240 in response to timing control signal LCTR OUT. Where power management unit 270 is embodied as software, state machine 273 can be a register inside or outside processor 210. In other embodiments, state machine 273 can be omitted, and comparison signal CMP can be provided directly as level control signal LCTR to voltage-clock provider 240.

FIG. 9 is a diagram illustrating a circuit that generates an output control signal in the power management unit of FIG. 8.

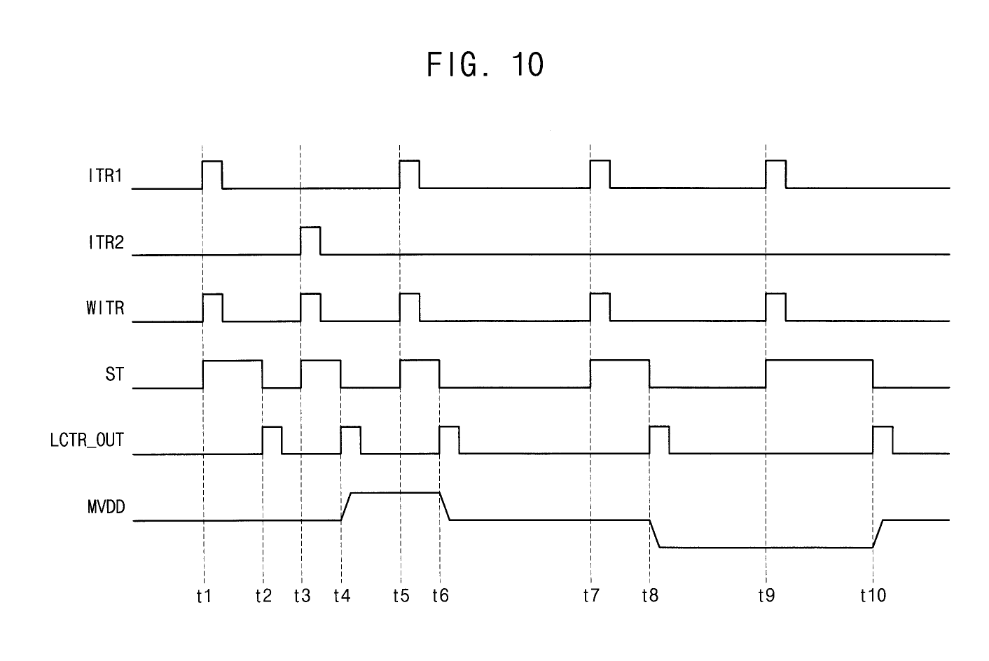

The circuit of FIG. 9 can be embodied in power management unit 270 or in interrupt controller 220. A pulse generator 274 activates a pulse signal PS where processor state signal ST is deactivated. An OR-gate generates timing control signal LCTR_OUT by OR-operation of pulse signal PS and a power level interrupt PTRI activated in the form of a pulse signal. As will be described with reference to FIG. 10, timing control signal LCTR_OUT can be activated in response to activation of power level interrupt PITR, that is, where the active mode is maintained longer than the reference time or where processor state signal ST is deactivated while the idle mode is launched. Power management unit 270 outputs level control signal LCTR to voltage-clock provider 240 in response to timing control signal LCTR_OUT. As a result, it is possible to control the timing with which the frequency of main clock signal MCLK and/or the magnitude of main power supply voltage MVDD are adjusted.

FIG. 10 is a timing diagram illustrating a method of performing power management in an electronic device according to an embodiment of the inventive concept.

Referring to FIG. 10, first interrupt ITR1 from system timer 230 comprises pulses generated periodically at times t1, t5, t7, and t9. Second interrupt ITR2 from I/O unit 250 comprises a pulse at a time t3 when a specific event occurs. The specific event can be, for instance, an input from a user through a keyboard or a touchpad. Interrupt controller 220 generates wake-up interrupt WITR in response to first interrupt ITR1 and second interrupt ITR2.

Wake-up interrupt WITR indicates a wake-up time of processor 210. For example, interrupt controller 220 can generate wake-up interrupt WITR by performing an OR-operation on first interrupt ITR1 and second interrupt ITR2. Wake-up interrupt WITR comprises pulses generated at times t1, t3, t5, t7, and t9.

Processor 210 changes its operation state from the idle mode to the active mode in response to the pulses of wake-up interrupt WITR. For example, processor state signal ST can be activated from a logic low level to a logic high level when the active mode is launched, e.g., at times t1, t3, t5, t7, and t9.

Switch 211 is turned on in response to activation of processor state signal ST, and then main clock signal MCLK is applied to processor 210. Processor state signal ST is deactivated from the logic high level to the logic low level in response to completion of the processing task by processor 210, and then timing control signal LCTR_OUT is activated in response to a falling edge of processor state signal ST. Timing control signal LCTR_OUT is activated in the shape of a pulse, and it comprises pulses generated when the active mode is launched, at times t2, t4, t6, and t8.

Voltage-clock provider 240 receives level control signal LCTR, which is provided in response to timing control signal LCTR_OUT, and then adjusts the frequency of main clock signal MCLK and/or the magnitude of main power supply voltage MVDD.

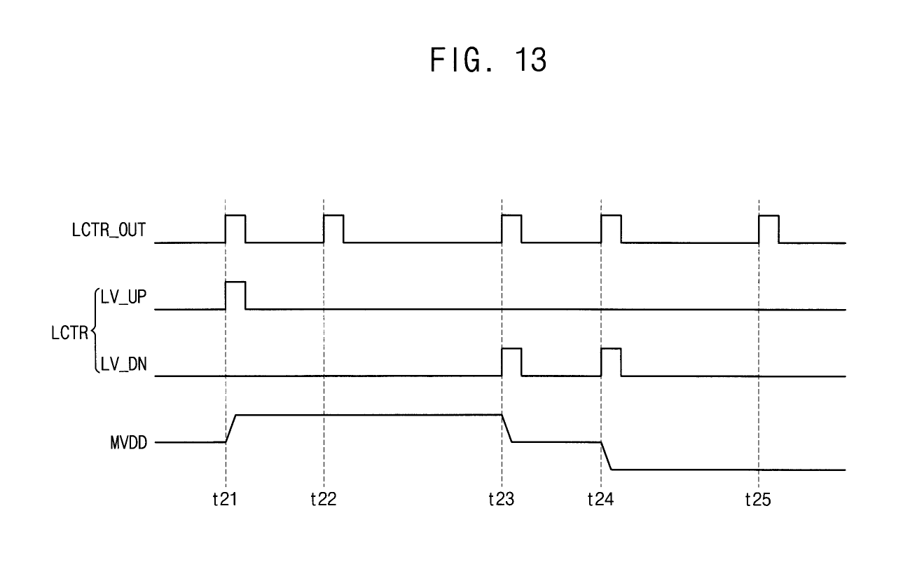

Although not illustrated in FIG. 10, level control signal LCTR will be described in further detail with reference to FIG. 13. Although not illustrated in FIG. 10, the frequency of main clock signal MCLK can be changed in addition to the magnitude of main power supply voltage MVDD, as illustrated in FIG. 2.

In the embodiment of FIG. 10, where the power level of processor 210 is scaled when the operation mode transitions from active mode to the idle mode, the power level stays the same at time t2, is increased to higher level at time t4, is decreased to lower level at time t6, is decreased again to lower level at time t8, and is increased to higher level at time t10. Accordingly, in the method of FIG. 10, the power level is scaled while the operation mode is transitions from the active mode to the idle mode, which can allow an unstable state of a voltage and/or frequency to occur in the idle mode, and can enhance the operational stability of processor 210.

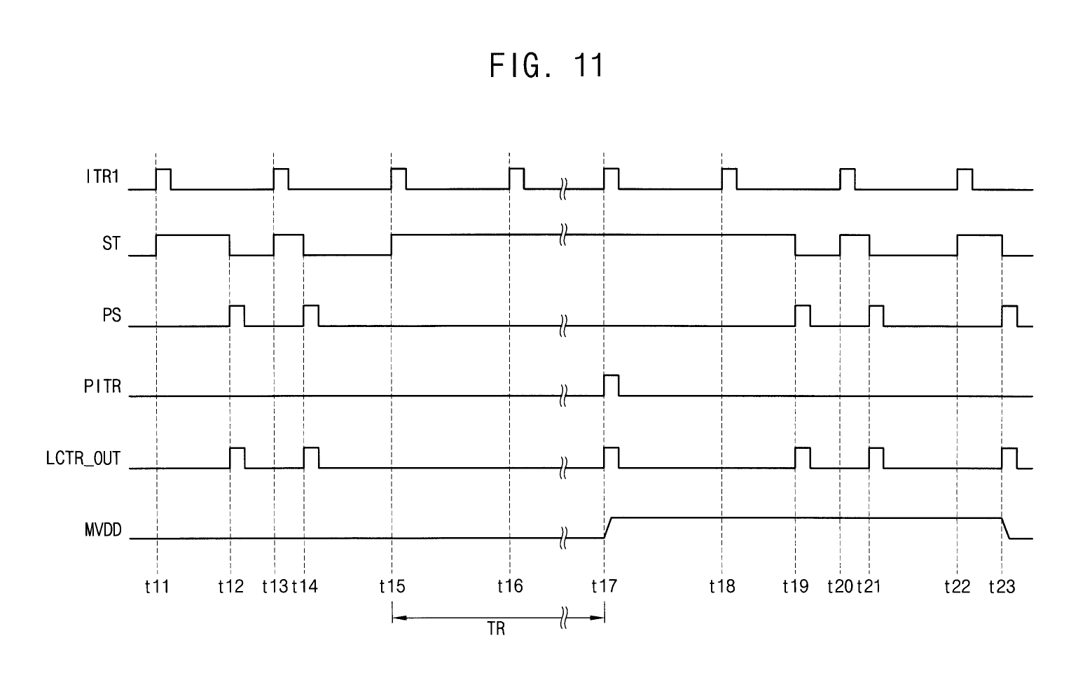

FIG. 11 is a timing diagram illustrating a method of performing power management according to another embodiment of the inventive concept.

In the embodiment of FIG. 11, the power level of processor 210 is scaled, regardless of a transition to the idle mode, where the active mode is maintained longer than reference time TR.

The active mode is launched at times t11, t13, t15, t20, and t22 in response to first interrupt ITR1, and the idle mode is launched at times t12, t14, t19, t21, and t23 after the processing task is completed. As indicated above with reference to FIG. 10 a logic high level of processor state signal ST indicates the active mode and the logic low level indicates the idle mode. Pulse signal PS and timing control signal LCTR_OUT have pulses at times t12, t14, t19, t21, and t23. Level control signal LCTR is applied to voltage-clock provider 240 in response to the pulses included in timing control signal LCTR_OUT, and consequently the power level is scaled where the operation mode transitions from the active mode to the idle mode.

Interrupt controller 220 activates power level interrupt PITR where the active mode is maintained longer than reference time TR. This can occur, for instance, where the activation of processor state signal ST is maintained longer than reference time TR. As illustrated in FIG. 11, power level interrupt PITR comprises a pulse at time t17, which is generated when the duration of the active mode exceeds reference time TR. In addition, timing control signal LCTR_OUT generated from OR-gate 275 comprises a pulse at time t17, during the active mode, and at times t12, t14, t19, t21, and t23, where the idle mode is launched.

Because level control signal LCTR is provided to voltage-frequency provider 240 in response to the pulses in timing control signal LCTR_OUT, the power level can be scaled when the active mode is maintained longer than reference time TR. Consequently, the operational stability of processor 210 can be maintained by performing power level scaling while the operation mode transitions from the active mode to the idle mode. Power level scaling can also be performed on processor 210 during the active mode to prevent a malfunction of processor 210 due to an overload.

In some embodiments, reference time TR is determined based on a number of interrupts provided from system timer 230, i.e. a number of pulses included in first interrupt ITR1. Interrupt controller 220 counts the number of activations of first interrupt ITR1 from system timer 230 during activation of processor state signal ST, and then interrupt controller 220 activates power level interrupt PITR where the number of the counts reaches a reference value.

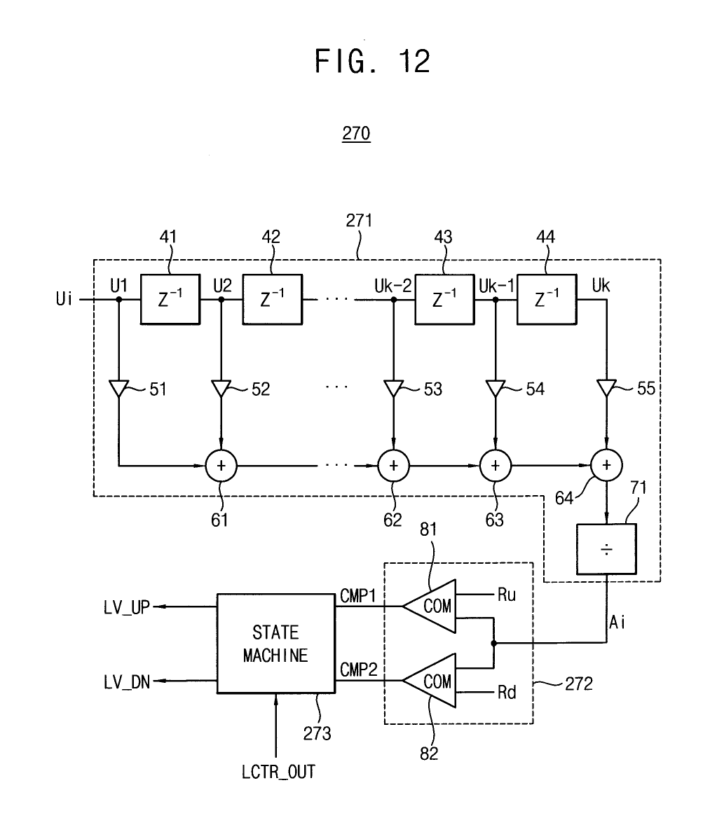

FIG. 12 is a circuit diagram illustrating a power management unit in the device of FIG. 6 according to an embodiment of the inventive concept.

In the embodiment of FIG. 12, power management unit 270 comprises a calculation unit 271, a comparison unit 272, and a state machine 273.

Calculation unit 271 receives the unit load rate Ui. Each unit load rate indicates a workload of processor 210 per unit time. Calculation unit 271 measures a present workload rate Ai by calculating an average of the unit load rates, and outputs the present workload rate Ai.

Calculation unit 271 comprises a plurality of buffers 41, 42, 43, 44, a plurality of amplifiers 51, 52, 53, 54, 55, a plurality of adders 61, 62, 63, 64 and a divider 71. Unit load rates Ui comprise load rates U1, U2, . . . , Uk, which are calculated based on workloads from processor 210 in consecutive order. Buffers 41, 42, 43, 44 can comprise any of various types of storage media. For example, buffers 41, 42, 43, 44 can be registers, or specific spaces of memory matched to specific addresses. Buffers 41, 42, 43, 44 can comprise delayers connected in series. The delayer can store the unit load rate Uj from a stage ahead, and output it with a next order Uj+1 to a next stage after a regular delay time. Buffers 41, 42, 43, 44 can be embodied by latches acting as a shift register.

Amplifiers 51, 52, 53, 54, 55 form an amplification unit that amplifies and outputs respective unit load rates of stages in buffers 41, 42, 43, 44. The gain of each amplifier can be set equally, or differently. For example, to apply larger weight to later unit load rate, the gain of the amplifier can be largest in first stage, decrease as it goes to a next stage, and reach a smallest value in a final stage.

Adders 61, 62, 63, 64 add the outputs of previous stages with an output of the amplifier in a present stage. Each adder calculates a sum of outputs from previous stage amplifiers. Divider 71 generates the present workload rate Ai by dividing the output of final amplifier 64 by the sum of the gains of the amplifiers.

By comparing the present workload rate Ai with upward reference value Ru and downward reference value Rd respectively, comparison unit 272 generates comparison signal CMP indicating whether to increase the power level or decrease the power level of processor 210.

Comparison unit 272 comprises a first comparison unit 81 and a second comparison unit 82. First comparison unit 81 compares the present workload rate Ai with upward reference value Ru and generates a first comparison signal CMP1, which is activated where the present workload rate Ai is larger than upward reference value Ru. Second comparison unit 82 compares present workload rate Ai with downward reference value Rd and generates a second comparison signal CMP2, which is activated where the present workload rate Ai is smaller than downward reference value Rd.

Comparison signals CMP1, CMP2 are stored in state machine 273, and state machine 273 provides level control signal LCTR for voltage-clock provider 240 in response to timing control signal LCTR_OUT. For example, level control signal LCTR comprises a level up signal LV_UP and a level down signal LV_DN. Activation of level up signal LV_UP indicates that the power level should be increased, and activation of level down signal LV_DN indicates that the power level should be decreased. Level up signal LV_UP and level down signal LV_DN can be activated in the shape of pulses.

Where power management unit 270 is embodied by software, state machine 273 can be a register inside or outside processor 210. In some embodiments, state machine 273 is omitted, and comparison signals CMP1, CMP2 are provided directly as level control signal LCTR to voltage-clock provider 240.

FIG. 13 is a timing diagram illustrating power level changes in a power management method according to an embodiment of the inventive concept.

As indicated above, timing control signal LCTR OUT comprises pulses at times t21, t22, t23, t24, t24. In addition, as explained above with reference to FIGS. 10 and 11, the pulses in time control signal LCTR_OUT indicate times where the idle mode is launched or the active mode is maintained longer than reference time TR. Although FIG. 13 only illustrates changes of the magnitude of main power supply voltage MVDD, the frequency of main clock signal MCLK can be changed together with main power supply voltage MVDD as described with reference to FIG. 2.

In the example of FIG. 13, the power level is raised by one level at time t21 as level up signal LV_UP is activated in the form of a pulse, and the power level stays the same at time t22 as level up signal LV_UP and level down signal LV_DN are both deactivated. The power level is decreased to a lower level at times t23 and t24 as the level down signal LV_DN is activated.

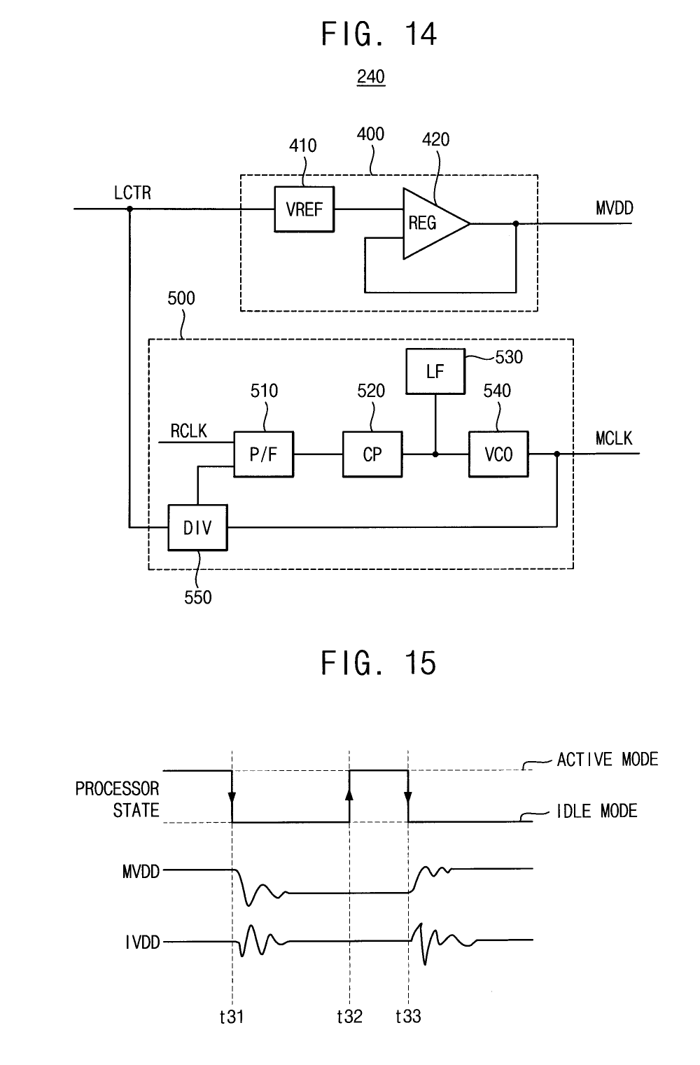

FIG. 14 is a diagram illustrating an example of the voltage-clock provider 240 in the device of FIG. 6 according to an embodiment of the inventive concept.

Referring FIG. 14, voltage-clock provider 240 comprises a voltage control unit 400 and a clock control unit 500.

Voltage control unit 400 comprises a reference voltage generator 410 and a regulator 420. Level control signal LCTR is applied to reference voltage generator 410, and then reference voltage generator 410 adjusts the reference voltage according to level control signal LCTR and provides the reference voltage to regulator 420. Regulator 420 compares the adjusted reference voltage with the magnitude of main power supply voltage MVDD and outputs power supply voltage MVDD to processor 210 with a magnitude corresponding to the level control signal LCTR.

In some embodiments, clock control unit 500 comprises a PLL. In such embodiments, level control signal LCTR from power management unit 270 is applied to frequency divider 550, and frequency divider 550 generates a frequency-divided clock signal by frequency-dividing main clock signal MCLK based on a frequency division ratio corresponding to level control signal LCTR.

A phase/frequency detector 510 compares a reference clock signal RCLK with the frequency-divided clock signal from frequency divider 550, and generates an up/down signal based on the comparison. A charge-pump 520 generates a control voltage based on the up/down signal. A voltage-controlled oscillator 540 generates main clock signal MCLK in response to the control voltage filtered by a loop-filter 530, and provides main clock signal MCLK to processor 210.

The magnitude of main power supply voltage MVDD and/or the frequency of main clock signal MCLK can be modified by adjusting the output of reference voltage generator 410 and/or the division ratio of frequency divider 550. Accordingly, the power level can be changed by adjusting level control signal LCTR.

FIG. 15 is a diagram for describing an effect of a power management method in an electronic device according to an embodiment of the inventive concept.

The diagram of FIG. 15 illustrates main power supply voltage MVDD and an operating current IVDD for an example where the power level is decreased to a lower level at a time t31 and is increased to a higher level at a time t33. Where the magnitude of main power supply voltage MVDD and/or the frequency of main clock signal MCLK changes, an unstable state occurs temporarily before the voltage and the current are stabilized, as illustrated in FIG. 15. In certain embodiments of the inventive concept, the power level is scaled while the operation mode is transitioned to the idle mode at times t31 and t33 and not after a transition to the active mode at time t32. Consequently, an unstable state of the voltage and/or the frequency is allowed to occur in the idle mode but not in the active mode, thereby preserving the operational stability of the electronic device.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims.

What is claimed is:

1. A method of managing power consumption in an electronic device comprising a processor, the method comprising:
launching an active mode of the device by applying a main clock signal to the processor; and
launching an idle mode of the device in parallel with scaling a power level of the processor.

2. The method of claim 1, wherein scaling the power level of the processor comprises adjusting a frequency of the main clock signal or a magnitude of a main power supply voltage of the processor based on a workload rate of the processor.

3. The method of claim 1, wherein launching the idle mode in parallel with scaling the power level of the processor comprises:
generating a level control signal after the processor completes a processing task; and
blocking the main clock signal from being applied to the processor after the processor completes the processing task.

4. The method of claim 3, wherein the processor is configured to perform a power management program to generate the level control signal, and
wherein the main clock signal is blocked from being applied to the processor after the level control signal is generated by the processor.

5. The method of claim 4, wherein at least one of the frequency of the main clock signal and a magnitude of a main power supply voltage is adjusted by a voltage-clock provider based on the level control signal.

6. The method of claim 4, wherein the power management program is a subroutine called by an operating system of the processor.

7. The method of claim 3, wherein the processor is configured to generate a processor state signal indicating the active mode or the idle mode of the processor, and
wherein the main clock signal is blocked from being applied to the processor after the processor state signal is deactivated to indicate the idle mode.

8. The method of claim 7, wherein the level control signal is generated by a power management unit based on the workload rate of the processor,
wherein the power management unit is located outside the processor and is configured to output the level control signal in response to the processor state signal, and
wherein at least one of a frequency of the main clock signal and a magnitude of a main power supply voltage of the processor is adjusted by a voltage-clock provider based on the level control signal received from the power management unit.

9. The method of claim 1, wherein the power level of the processor is scaled as a consequence of the active mode being maintained for a reference time.

10. The method of claim 9, wherein the reference time is determined based on a number of interrupts generated by a system timer.

11. The method of claim 2, wherein the work load rate of the processor is measured by calculating an average of a plurality of unit load rates, wherein each unit load rate indicates a workload of the processor per unit time.

12. The method of claim 2, wherein the workload rate of the processor is measured by calculating a weighted average of a plurality of unit load rates, wherein each unit load rate indicates a workload of the processor per unit time, and a greater weigh is applied to a more recent unit load rate among the plurality of unit load rates than to a less recent unit load rate among the plurality of unit load rates.

13. The method of claim 2, wherein the workload rate of the processor is generated by a workload detector located outside the processor.

14. The method of claim 2, wherein the workload rate of the processor is generated by a subroutine called by an operating system of the processor.

15. The method of claim 9, wherein a power level interrupt signal is generated by an interrupt controller outside the processor where the active mode is maintained for the reference time, and
wherein the power level of the processor is scaled in response to the power level interrupt signal.

16. The method of claim 15, wherein the power level interrupt signal is generated based on a number of interrupts provided from a system timer and a processor state signal, wherein the processor state signal indicates the active mode or the idle mode of the processor.

17. An electronic device having an active mode and an idle mode, the device comprising:
a processor that operates according to a main clock signal and a main power supply voltage; and
a voltage-clock provider that provides the main clock signal and the main power supply voltage to the processor, and scales a power level of the electronic device during a transition of the electronic device from the active mode to the idle mode by reducing a frequency of the main clock signal or a magnitude of the main power supply voltage.

18. The electronic device of claim 17, further comprising a switch that disconnects the main clock signal from the processor during the transition of the electronic device from the active mode to the idle mode.

19. A method of operating an electronic device comprising a processor and a voltage-clock provider that provides a main clock signal and a main power supply voltage to the processor, the method comprising:
performing a processing task on the processor;
upon completion of the processing task, executing a power management program on the processor to actuate a level control signal and a processor state signal;
in response to the actuation of the processor state signal, operating a switch to interrupt the supply of the main clock signal to the processor; and
in response to the level control signal and in parallel with the operation of the switch, operating the voltage-clock provider to reduce a frequency of the main clock signal or a magnitude of the main power supply voltage.

20. The method of claim 19, wherein the power management program is implemented in a software routine of an operating system of the processor.
